(19) United States
(12) Patent Application Publication
(10) Pub. No.: US 2026/0304527 A1
(43) Pub. Date: Oct. 1, 2026

(54) POWER CONSERVATION FOR WIRELESS COMMUNICATIONS FAILURE

(71) Applicant: Motorola Mobility LLC, Chicago, IL (US)

(72) Inventors: Daniel C. Chisu, Franklin Park, IL (US); Matthew Lee Deheck, Vernon Hills, IL (US)

(73) Assignee: Motorola Mobility LLC, Chicago, IL (US)

(21) Appl. No.: 19/096,302

(22) Filed: Mar. 31, 2025

(51) Int. Cl. H04W 76/16; H04W 64/00; H04W 76/19

(52) U.S. Cl. CPC H04W 76/16; H04W 64/00; H04W 76/19

(57) ABSTRACT

In aspects of power conservation for wireless communications failure, a device detects a communication failure at a first wireless carrier that supports a first radio access technology. The device pauses one or more scans to establish a first wireless communications link with the first wireless carrier based on the communication failure. The device establishes a second wireless communications link (e.g., with a second wireless carrier or with a landline service) that supports a second radio access technology. The device periodically receives information (e.g., outage reports) associated with the communication failure via the second wireless communications link. The device resumes the one or more scans to establish the first wireless communications link based on the information.

### BACKGROUND

Devices, such as smart devices, mobile devices (e.g., cellular phones, tablet devices, smartphones), consumer electronics, and the like, can be implemented for use in a wide range of environments and for a variety of different applications. The devices may communicate with other devices using wireless networks or wireless carriers, such as via wireless communications links that are established between the device and the other devices for various radio access technologies or types of wireless networks. Example radio access technologies or types of wireless networks include, but are not limited to, cellular radio access technologies, Wi-Fi radio access technologies, cellular wireless networks, and wireless local area networks (WLANs).

### BRIEF DESCRIPTION OF THE DRAWINGS

Implementations of the techniques for power conservation for wireless communications failure are described with reference to the following Figures. The same numbers may be used throughout to reference like features and components shown in the Figures:

FIG. 1 illustrates an example system for power conservation for wireless communications failure in accordance with one or more implementations as described herein.

FIG. 2 illustrates an example report diagram for power conservation for wireless communications failure in accordance with one or more implementations as described herein.

FIG. 3 illustrates an example flowchart for power conservation for wireless communications failure in accordance with one or more implementations as described herein.

FIG. 4 illustrates an example user interface for power conservation for wireless communications failure in accordance with one or more implementations as described herein.

FIGS. 5 and 6 illustrate examples of methods for power conservation for wireless communications failure in accordance with one or more implementations of the techniques described herein.

FIG. 7 illustrates various components of an example device that can be used to implement the techniques for power conservation for wireless communications failure as described herein.

### DETAILED DESCRIPTION

Implementations of techniques for power conservation for wireless communications failure are described herein. In some examples, a device (e.g., a mobile device, a client device, a wearable device, or any other device) can implement one or more applications or services that manage wireless communications failures. For example, the device implements one or more applications or services that detect a communication failure at a primary wireless communications link between the device and a network provider. The primary wireless communications link may be an example of a wireless communications link for access to a wireless carrier (e.g., a cellular network), and the network provider may be a device that provides one or more wireless communications services, including a base station or other network equipment. A wireless carrier is an entity that provides cellular network services, including voice, data, and messaging, to one or more devices. The device may pause scanning (e.g., monitoring for signaling) related to establishing or reestablishing the failed primary wireless communications link. The device may establish a secondary wireless communications link between the device and an application server. The secondary wireless communications link may be an example of a wireless communications link for access to a different wireless carrier, such as to a Wi-Fi network. The device may use the secondary wireless communications link to obtain information (e.g., reports) about the communication failure on the primary wireless communications link. The device can use the information to determine when to resume scanning to establish the primary wireless communications link.

Conventional techniques for a device to reestablish or establish a failed wireless communications link may include continuous attempts or scans to reestablish or establish the failed wireless communications link, which can lead to increased power consumption at the device and inefficient use of communication resources (e.g., time resources, frequency resources, and/or spatial resources). For example, the device may lose connection with one or more other devices, such as one or more network provider devices for a wireless carrier in a cellular network, during an outage of the cellular network. The outage may be due to communication failures at network infrastructure of the cellular network (e.g., the network provider devices in the cellular network), which may be caused by environmental factors (weather, natural disasters, etc.), equipment malfunctions (hardware failures, software failures, power outages, etc.), network congestion or interference, physical obstructions, maintenance of the network infrastructure, and/or cyberattacks targeting the network infrastructure, among other examples. If the device detects a communication failure, then the device may continuously perform out-of-service (OOS) scans (e.g., according to a periodicity less than a threshold value, every 60 seconds) by monitoring for signaling from a network provider device to reestablish or establish a failed wireless communications link. The device continuously performing the OOS scans (e.g., for a home public land mobile network (HPLMN)) leads to increased power consumption and signaling overhead at the device due to monitoring for the signaling. Additionally, or alternatively, the increased signaling overhead leads to inefficient use of communication resources, as the attempts to reestablish or establish a failed wireless communications link may not be successful.

As described herein, to improve power consumption at the device by reducing attempts to reestablish or establish a failed wireless communications link, a device may pause scans to establish the failed wireless communication link upon detecting the communication failure. For example, if the device detects a communication failure on a primary wireless communications link with a network provider device, then instead of continuously attempting to reestablish the connection or to establish a new connection via the primary wireless communications link, the device pauses (e.g., does not perform, cancels) the attempts and establishes a secondary wireless communications link. In some cases, the device establishes the secondary wireless communications link with an application server via a secondary radio access technology, such as Wi-Fi. In some other cases, the device establishes the secondary wireless communications link with the application server via a same radio access technology as the primary wireless communications link (e.g., cellular), and using a different wireless carrier from the primary wireless communications link. Thus, the secondary wireless communications link can support a different wireless carrier or can support the use of an alternative radio access technology. The device then uses the secondary wireless communications link to periodically obtain information about the status of the communication failure on the primary link from the application server. The information may include one or more outage reports for a geographic location that the device is within. Based on the information, the device can determine when to resume attempts to establish the primary wireless communications link (e.g., when a rate of change of reports indicating a communication failure decreases).

By pausing scans and/or attempts to reestablish or establish a failed primary wireless communications link, the device reduces power consumption during network outages. For example, the use of a secondary wireless communications link to receive relevant information about a failure of a primary wireless communications link allows the device to determine when to resume scanning, rather than blindly attempting to reestablish or establish the primary wireless communications link at continuous, fixed intervals. As the device is not continuously scanning, the device uses less power.

While features and concepts of the described techniques for power conservation for wireless communications failure can be implemented in any number of different devices, systems, environments, and/or configurations, implementations of the techniques for power conservation for wireless communications failure are described in the context of the following example devices, user interfaces, systems, and methods.

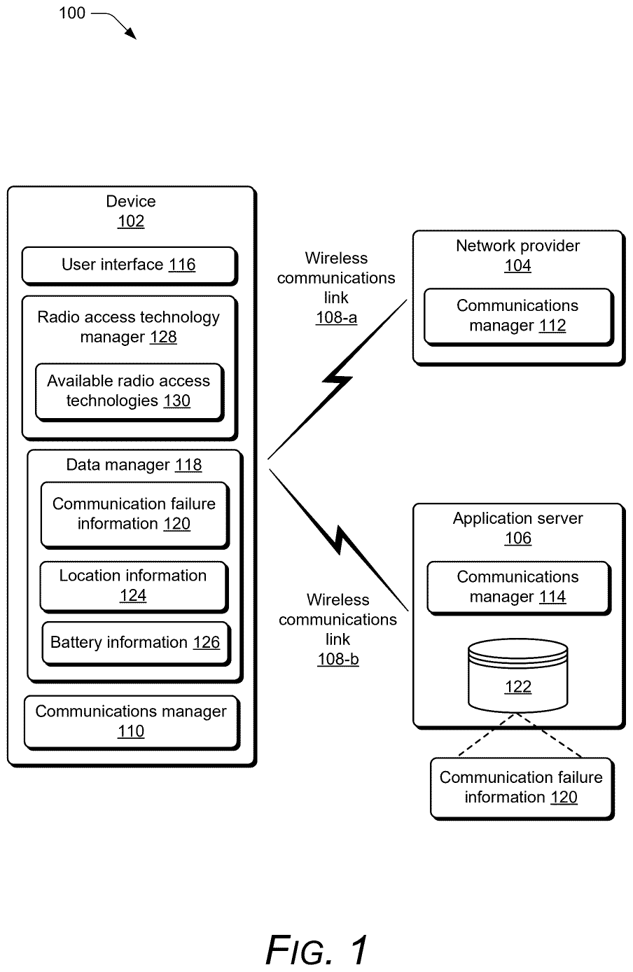

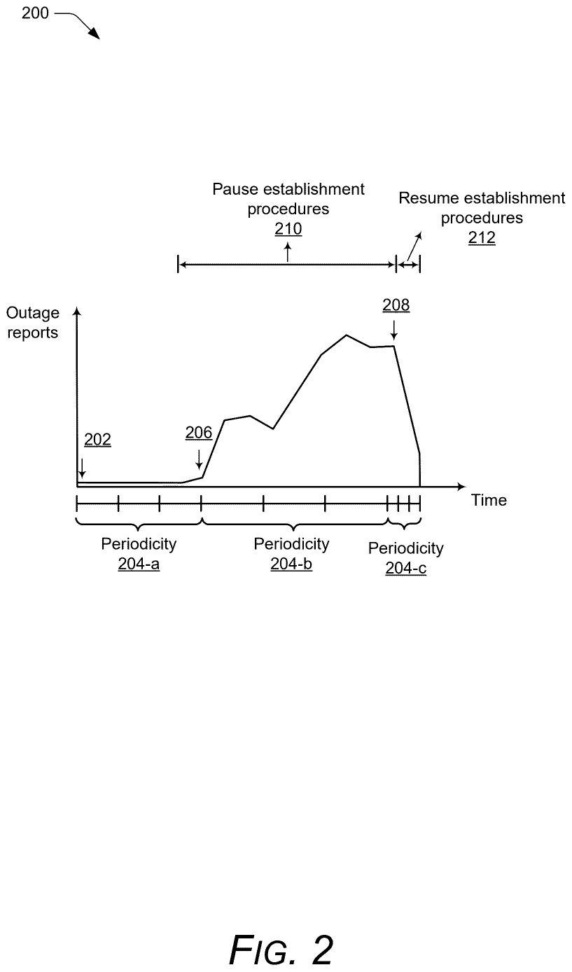

FIG. 1 illustrates an example system 100 for power conservation for wireless communications failure, as described herein. The example system 100 includes a device 102, a network provider 104, and an application server 106, where the device 102, the network provider 104, and the application server 106 are interconnectable via one or more networks. For example, the device 102 and the network provider 104 may exchange signaling, including control signaling and/or data, via a wireless communications link 108-a, which may also be referred to as a primary wireless communications link. The device 102 and the application server 106 may exchange signaling, including control signaling and/or data, via a wireless communications link 108-b, which may also be referred to as a secondary wireless communications link. Although the system 100 illustrates the device 102, the network provider 104, and the application server 106 as being separate entities, in some examples, two or more of these components may be combined at a single device (e.g., a server device) or collocated. Further, the network provider 104 and the application server 106 may exchange signaling, including control signaling and/or data, via a wireless communications link over the air and/or a wired communications link.

The device 102, the network provider 104, and the application server 106 may range from a full resource devices or systems with substantial memory and processor resources to a low-resource devices or systems with reduced memory and/or processing resources. Although in instances in the following discussion reference is made to a device 102, a network provider 104, and an application server 106, respectively, in the singular, these components may also be representative of multiple different devices or systems. The device 102, the network provider 104, and the application server 106 may include one or more features in addition to, or as an alternative to, the features illustrated in the system 100.

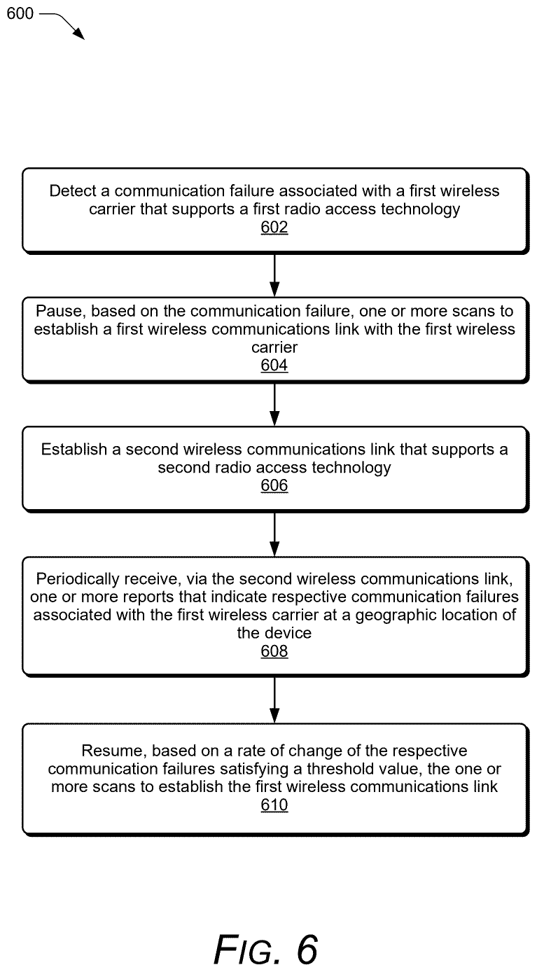

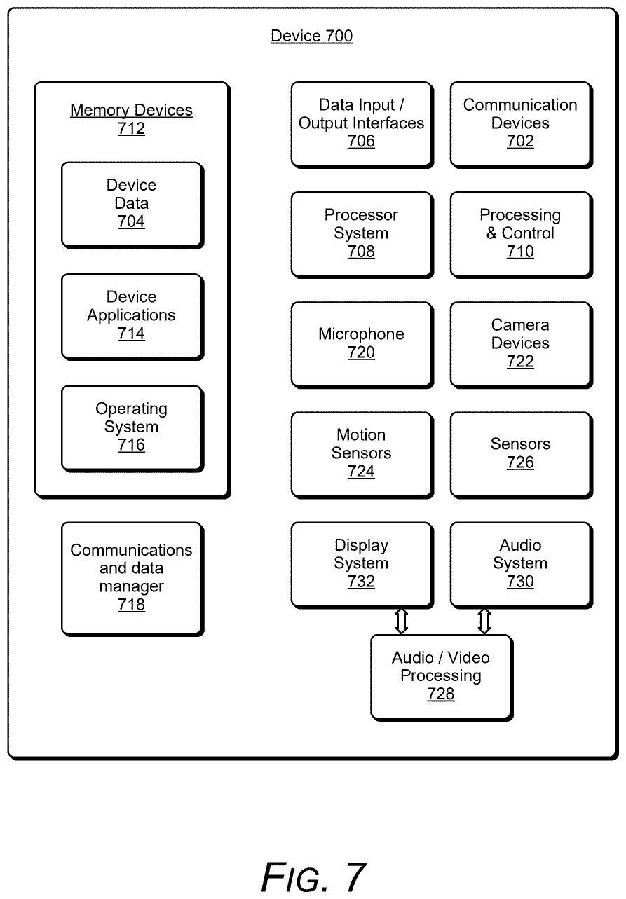

In some examples, the device 102 is an example of a user equipment (UE), a smartphone, a mobile phone, a wearable device, and/or any other type of wireless device or mobile device. The device 102 can be implemented with various components, such as a processor system and memory, as well as any number and combination of different components as further described with reference to the example device shown in FIG. 7. The device 102 may implement or incorporate various components and/or functionality to detect a communication failure on a wireless communications link 108-a, establish a wireless communications link 108-b, and manage a process to obtain outage information for determining when to resume connection attempts with the network provider 104.

The network provider 104 may include and/or may be implemented by one or more devices in a wireless network (e.g., a cellular network, a Wi-Fi network, or other wireless network). The network provider 104 may additionally, or alternatively, be referred to as a service provider, a service provider device, and/or a network provider device. The network provider 104 may include or may be implemented by a network equipment (NE), including a base station or other network entity, a core network (CN), or any other network infrastructure. The network provider 104 may maintain the wireless communications link 108-a with the device 102 for a wireless carrier. The network provider 104 and/or the device 102 may establish the wireless communications link 108-a to exchange (e.g., send, transmit, receive, output, obtain, monitor for) signaling. For example, the device 102 may initiate a connection request to establish the wireless communications link 108-a by transmitting a message to the network provider 104. The network provider 104 may respond with a response message that allocates communication resources (e.g., time resources, frequency resources, and/or spatial resources) for the device 102 to send additional connection setup messages. The device 102 and network provider 104 may then exchange authentication and security-related signaling to establish the wireless communications link 108-a. Once the wireless communications link 108-a is established, the network provider 104 and the device 102 may exchange data and/or control signaling via the wireless communications link 108-a.

The application server 106 may be implemented by or may implement aspects of an application, such as an outage tracking application. The application server 106 may receive (e.g., obtain, collect) and aggregate information related to communication failures from multiple devices, including the device 102. The application server 106 may provide the device 102 with the information via a wireless communications link 108-b, such that the device 102 may determine when to establish a failed wireless communications link. The application server 106 and/or the device 102 may establish the wireless communications link 108-b to exchange (e.g., send, transmit, receive, output, obtain, monitor for) signaling for a different wireless carrier than the wireless communications link 108-a. For example, the device 102 may initiate a connection request by exchanging one or more messages (e.g., transmitting and/or receiving the messages) with a network for establishing the wireless communications link 108-b. The wireless communications link 108-b may provide the device 102 with access to the application server 106. Once the wireless communications link 108-b is established, the application server 106 and the device 102 may exchange data and/or control signaling for the wireless carrier via the wireless communications link 108-b.

In some cases, the network provider 104 and the application server 106 may implement different radio access technologies and wireless carriers. A radio access technology may refer to different types of wireless networks and/or connection procedures for the different types of wireless networks. For example, the network provider 104 may utilize a cellular radio access technology, such as 4G Long-Term Evolution (LTE) or 5G New Radio (NR), while the application server 106 may be accessible through a Wi-Fi radio access technology. A wireless carrier provides services via the radio access technologies, including voice, data, and messaging, to the device 102. Thus, the device 102 may establish connections via multiple radio access technologies for improved connectivity and communication failure management. For example, if a wireless communications link 108-a with a wireless carrier that supports the cellular radio access technology experiences a communication failure, then the device 102 may establish the wireless communications link 108-b with a different wireless carrier that supports the Wi-Fi radio access technology to communicate with the application server 106. Using the multiple radio access technologies may provide for the device 102 to maintain network connectivity if there is a communication failure at a radio device for one of the radio access technologies.

In some examples, the device 102 may include and/or implement a communications manager 110, the network provider 104 may include and/or implement a communications manager 112, and the application server 106 may include and/or implement a communications manager 114. The communications manager 110, the communications manager 112, and the communications manager 114 facilitate wireless communication and manage the exchange of data related to network outages and connection establishment and/or reestablishment. The communications manager 110 at the device 102 is responsible for detecting communication failures on the wireless communications link 108-a (e.g., for a cellular network, for a cellular wireless carrier), establishing a wireless communications link 108-b (e.g., for a Wi-Fi network, for a Wi-Fi wireless carrier), and coordinating the exchange of information with the application server 106. The communications manager 110 also manages the pausing and resuming of signaling related to reestablishing the wireless communications link 108-a according to the information, which may include outage data. The communications manager 112 at the network provider 104 manages wireless communications links with connected devices and may provide information about the network to the application server 106. The communications manager 114 at the application server 106 manages the collection and distribution of information (e.g., outage data) to devices.

The user interface 116 at the device 102 provides for user input and/or output of information to a user. For example, the user interface 116 may display notifications about network outages, display a status of connection attempts, and display interactable elements for obtaining user input to manually control connection reestablishment procedures, among other examples. For example, the user interface 116 might present a notification stating “Network outage detected. Scanning paused to conserve battery,” along with options to “Resume scanning” or “Check outage status.”

The data manager 118 at the device 102 processes and analyzes communication failure information 120 received from the application server 106 to determine when to pause and resume scanning for connection reestablishment. The device 102 may detect a communication failure at the wireless communications link 108-a, such that a wireless connection between the device 102 and the network provider 104 is disrupted. The device 102 may pause the scans to reestablish or establish the wireless communications link 108-a (e.g., a failed wireless communications link) and may establish the wireless communications link 108-b for a different wireless carrier and radio access technology than the wireless communications link 108-a with the communication failure. In some examples, if the device 102 is unable to establish the wireless communications link 108-b, such as if there is no secondary wireless carrier and radio access technology available to the device 102, then the device 102 may not pause the scans to reestablish or establish the wireless communications link 108-a until the device 102 is able to establish the wireless communications link 108-b. Additionally, or alternatively, the device 102 may scan to establish the wireless communications link 108-b according to a dynamic (e.g., configurable) periodicity. The dynamic periodicity for establishing the wireless communications link 108-b may be adjusted according to input, a geographic location of the device 102, or may be determined by the device 102.

Once the device 102 has established the wireless communications link 108-b, the device 102 may query the application server 106 to obtain the communication failure information 120. For example, the device 102 may periodically transmit a request for the communication failure information 120 via the wireless communications link 108-b. The periodicity according to which the device 102 transmits the request may be dynamic. For example, the periodicity may change according to the communication failure information 120 (e.g., based on a selection of a periodicity by the device 102 or input) or may be configured to vary according to a geographic location of the device 102 or a duration over which the communication failure information 120 is request, among other examples. The device 102 may receive the communication failure information 120 from the application server 106 in response.

The communication failure information 120 may include data related to network outages or connectivity issues (e.g., communication failures for various network providers and/or wireless carriers). Examples of communication failure information 120 may include, but is not limited to, a numerical quantity (e.g., number, amount, quantity) of reported outages in a defined geographic location, a numerical quantity of reported outages for a wireless carrier, a duration of an ongoing outage, and/or trends in communication failure rates over time. The data manager 118 at the device 102 may implement algorithms to interpret trends in outage reports, such as detecting an increasing or decreasing rate of reported communication failures. Based on the analysis, the data manager 118 may send instructions to the communications manager 110 to adjust a frequency or periodicity of connection attempts (e.g., scans) and/or of obtaining the communication failure information 120 from the application server 106 to improve power consumption, while maintaining responsiveness to network recovery. The device 102 obtains the communication failure information 120 by periodically querying the application server 106 using the wireless communications link 108-b, such as according to a configurable or dynamic periodicity.

The data manager 118 may parse incoming reports in the communication failure information 120 to detect whether an outage is reported for a defined geographic location (e.g., region, area), for a wireless carrier, or for a network provider (e.g., the network provider 104). The defined geographic location may be a geographic location that the device 102 is within. In some cases, the data manager 118 may utilize a machine learning model trained on historical outage data to predict the likelihood and duration of ongoing outages. The device 102 may dynamically adjust the frequency or the periodicity of attempts to establish a wireless communications link to replace the failed wireless communication link or to reestablish the failed wireless communication link based on the analysis of the communication failure information 120. For example, if a rate of change of reported outages is decreasing, then the data manager 118 may instruct the communications manager 110 to resume attempts to establish a wireless communications link 108-a and/or to increase a frequency or periodicity of attempts to establish a wireless communications link 108-a. In some other examples, if a rate of change of reported outages is increasing or remaining at a relatively high level (e.g., greater than a threshold numerical quantity of reported outages), then the data manager 118 may continue to pause attempts to establish the wireless communications link 108-a and/or may reduce a numerical quantity of attempts to establish the wireless communications link 108-a.

In some cases, the device 102 may additionally, or alternatively, adjust the periodicity for obtaining the communication failure information 120 from the application server 106 based on the analysis of the communication failure information 120. For example, the data manager 118 may decrease a frequency or periodicity of queries to the application server 106 when a rate of change of reported outages is increasing or remaining at a relatively high level (e.g., greater than a threshold numerical quantity of reported outages) to reduce signaling overhead and power consumption at the device 102. As the rate of change of reported outages decreases, the data manager 118 may increase the frequency or periodicity of queries to the application server 106 to ensure that the device 102 does not remain in an unconnected state while the cellular network (e.g., the network provider 104) is back online.

In some examples, the device 102 may detect a trigger that overrides the periodicity or frequency for querying the application server 106 for the communication failure information 120 and/or that causes the device 102 to resume the attempts to reestablish the wireless communications link 108-a. Example triggers may include, but are not limited to, receiving signaling from another device indicating network availability, detecting a change in location of the device 102, or receiving user input to resume scanning. If the device 102 detects a trigger, then the device 102 may query the application server 106 for communication failure information 120 and/or may resume communication of signaling related to reestablishing the wireless communications link 108-a, regardless of the current periodicity. Based on the communication failure information 120, the device 102 may determine whether to resume attempts to reestablish the wireless communications link 108-a or continue pausing the attempts.

In some examples, the application server 106 stores the communication failure information 120 at data storage 122. The data storage 122 at the application server 106 may be implemented as a database system capable of performing real-time updates and queries, providing for efficient storage and retrieval of outage data from multiple sources. For example, multiple devices may connect to a wireless network (e.g., a Wi-Fi network) and upload reports to the application server 106. The devices may include smartphones, tablets, laptops, or other wireless-enabled devices that are experiencing communication failures at a primary wireless network (e.g., a cellular network). Once connected, the devices may transmit reports that include a geographic location, which may be determined using a global positioning system (GPS), cell tower triangulation, or Wi-Fi positioning techniques. The reports may include a network provider experiencing the outage, the type of the device, the duration of the outage, and any error codes or messages received. The application server 106 may aggregate the reports from multiple devices in a same geographic location.

In some examples, the device 102 may determine location information 124 that indicates a geographic location of the device 102. The device 102 may transmit the location information 124 to the application server 106 (e.g., in a request for the communication failure information 120 and/or in a separate message). The application server 106 may use the location information 124 to determine which communication failure information 120 to transmit to the device 102. For example, the device 102 might use GPS coordinates to request outage information for a current geographic location of the device 102 (e.g., a current city or cellular network region). Additionally, or alternatively, the device 102 may use the location information 124 to select or determine relevant communication failure information 120 (e.g., one or more relevant reports form a set of reports included in the communication failure information 120). The device 102 may obtain battery information 126, including data related to a current power status of the device 102. The device 102 may use the battery information 126 to adjust the frequency of outage information requests or connection attempts. For example, if the battery level is below a threshold value, then the device 102 may reduce a frequency of queries to the application server 106 or extend the intervals between connection attempts to conserve power.

In some cases, the device 102 includes a radio access technology manager 128 to manage available radio access technologies 130 accessible by the device 102 with radio devices (e.g., antennas) of the device 102. The radio access technology manager 128 may provide for the device 102 to switch between radio devices of the device 102 (e.g., antennas) for the different wireless communication methods according to communication failures. For example, the radio access technology manager 128 may cause (e.g., transmit instructions to a processor of the device to cause) the device 102 to transition from a cellular connection (e.g., 4G or 5G) to a Wi-Fi connection when a communication failure is detected at a wireless communications link for the cellular connection. The available radio access technologies 130 may include cellular networks (e.g., 3G, 4G, 5G), Wi-Fi (e.g., 802.11ac, 802.11ax), Bluetooth, or other wireless communication types that the device 102 supports.

By implementing the communications manager 110, the communications manager 112, and the communications manager 114 in conjunction with the data manager 118 and the radio access technology manager 128, the device 102 provides for dynamic management of connection establishment during communication failures (e.g., network outages). The dynamic management reduces power consumption from continuous scanning (e.g., OOS scans). The use of a wireless communications link 108-b to obtain communication failure information 120 from the application server 106 provides for the device 102 to determine when to resume connection attempts. The integration of location information 124 and battery information 126 enhances a capability of the device 102 to adapt to the communication failure context, providing an efficient and dynamic procedure for managing wireless communication failures.

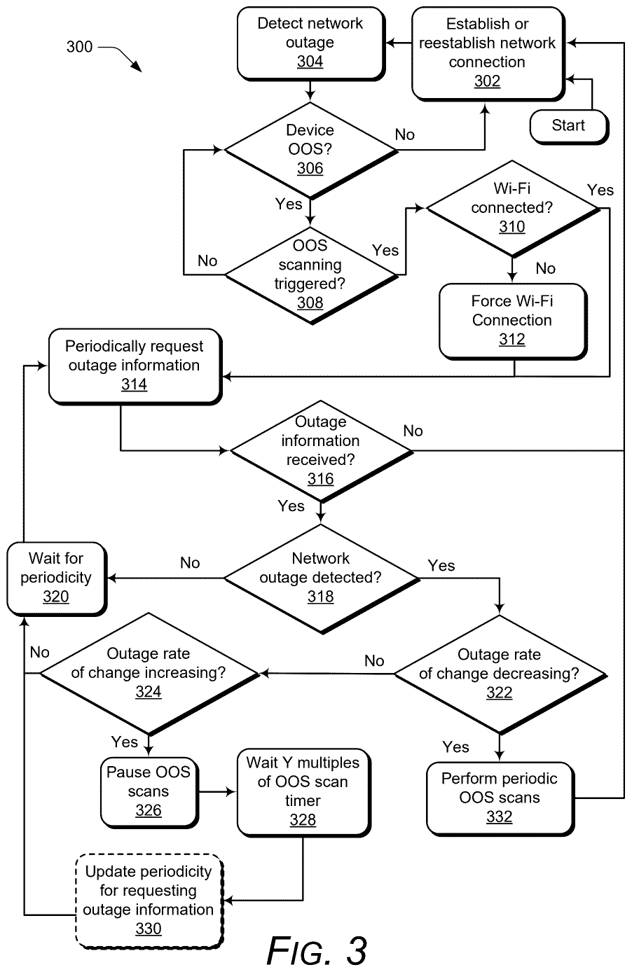

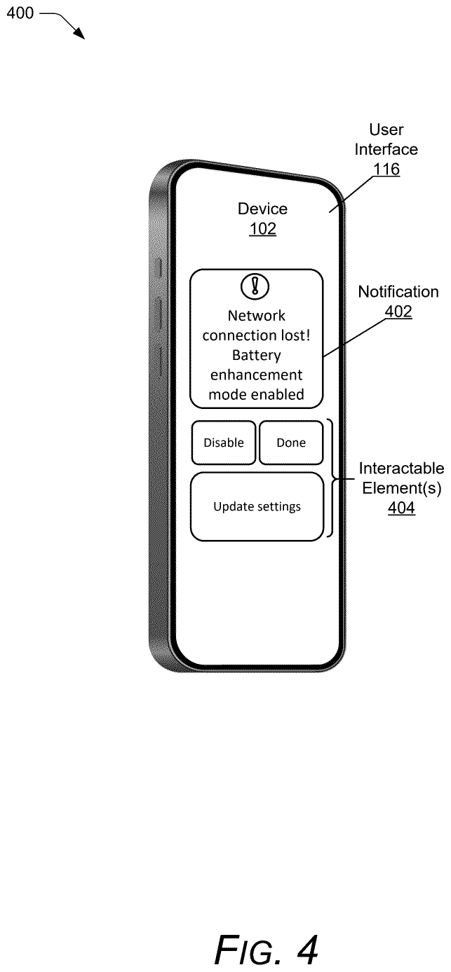

FIG. 2 illustrates an example report diagram 200 for power conservation for wireless communications failure in accordance with one or more implementations as described herein. The report diagram 200 may implement or be implemented by aspects of the example system 100. For example, the report diagram 200 can be analyzed by a device to determine when to attempt to reestablish a failed connection for wireless communications, where the device may be an example of a device 102 as described with reference to FIG. 1. The report diagram 200 illustrates a numerical quantity (e.g., number, amount, quantity) of outage reports over time for a wireless communications network.

At 202, a device may detect a communication failure and may transmit a first or initial query or request to an application server for communication failure information. The application server may transmit initial outage report level, which may be relatively low (e.g., close to zero). The device may begin a timer, such that the device queries the application server once the timer expires and according to a periodicity 204-a. The periodicity 204-a may be an initial, default periodicity (e.g., determined by the device or set via user input).

At 206, a rate of change of reported outages may increase, indicating that a communication failure is not resolved. Thus, the device may update a timer to a different value, such as the periodicity 204-b. The periodicity 204-b may be greater than the periodicity 204-a, such that the device requests the communication failure information less frequently. At 208, the device may determine that a rate of change of reported outages is decreasing, indicating that the communication failure may be resolved. Thus, the device may resume attempts to reestablish a failed wireless communications link according to a periodicity 204-c. The periodicity 204-c may be less than the periodicity 204-a and the periodicity 204-b, such that the device transmits signaling related to reestablishing the wireless communications link more frequently.

In some examples, during a time period of increased outage reports, the device may pause establishment procedures 210. That is, the device may temporarily cancel attempts to reconnect to a primary wireless network to conserve battery power. As the number of outage reports begins to decrease, the device may resume establishment procedures 212. For example, the device may determine a communication failure may be resolved and may resume (e.g., continue) attempts to establish the primary wireless communications link.

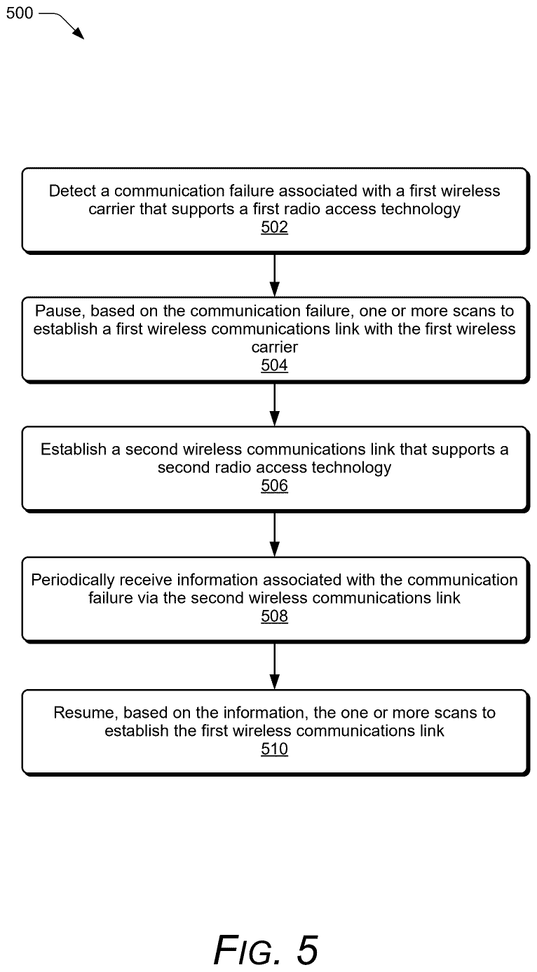

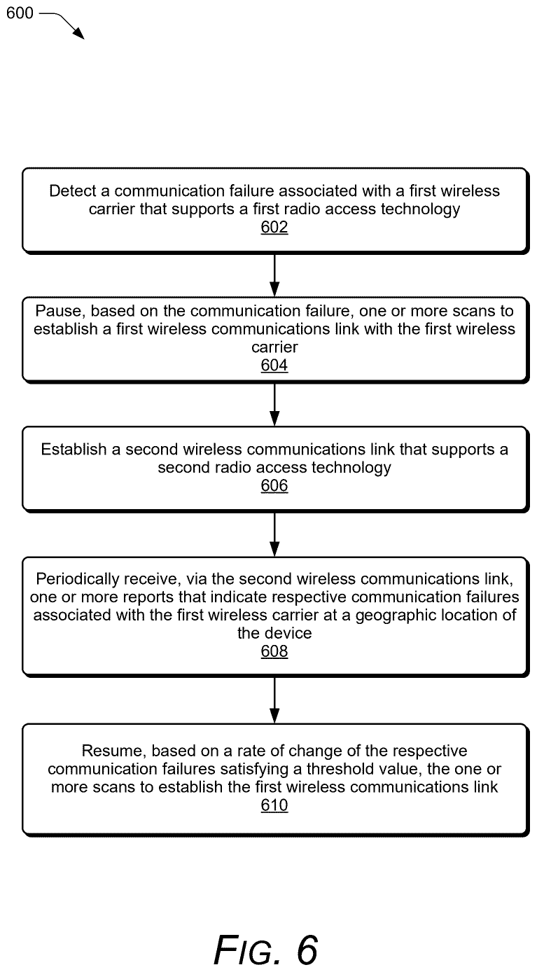

FIG. 3 illustrates an example flowchart 300 for power conservation for wireless communications failure in accordance with one or more implementations as described herein. The example flowchart 300 may implement aspects of the example system 100 and the example report diagram 200. For example, the example flowchart 300 can be implemented by a device, which may be an example of the device 102 as described with reference to FIG. 1. Alternative examples of the following may be implemented, where some processes are performed in a different order than described or are not performed. In some cases, processes may include additional features not mentioned below, or further processes may be added.

At 302, a network connection is established or reestablished. For example, a device may establish a primary wireless communications link with a network provider for a cellular network.

At 304, a network outage is detected. For example, the device may determine there is a communication failure on a primary wireless communications link (e.g., an HPLM is lost). The device may detect the network outage by failing to receive feedback from a network provider or other device responsive to transmitted signaling. Additionally, or alternatively, the device may receive an explicit indication of the network outage.

At 306, a determination is made as to whether the device is OOS. If the device is not OOS (e.g., “No”), then the device attempts to reestablish the network connection at 302. For example, the device may perform a telescopic backoff scan, which may include a scan for reestablishing or establishing the network connection 20 seconds after detecting the network outage, then 30 seconds after the previous scan, then 40 seconds after the previous scan, until 60 seconds. If the device fails to establish the network connection after the 60 second scan has been performed, then the device may be OOS. If the device is OOS (e.g., “Yes”), then at 308, a determination is made as to whether OOS scanning is triggered. If OOS scanning is not triggered (e.g., “No”), then the device makes another determination as to whether the device is OOS at 306.

If OOS scanning is triggered (e.g., “Yes”), then at 310, a determination is made as to whether Wi-Fi is connected. For example, the device may attempt to establish a secondary wireless communications link with a secondary wireless carrier. If Wi-Fi is not connected (e.g., “No”), then at 312, a Wi-Fi connection is forced. That is, the device may display a notification to via a user interface that indicates for the user to establish a connection with a secondary network (e.g., a Wi-Fi network). Additionally, or alternatively, the device may attempt to establish the secondary wireless communications link with an additional (e.g., alternative) wireless carrier using a secondary subscriber identity module (SIM) card operating on the same device. For example, the device may implement a dual SIM dual standby (DSDS) mode or a dual SIM dual active mode to establish a secondary wireless communications link with a secondary wireless carrier. Additionally, or alternatively, the device may attempt to establish a secondary wireless communications link with another device via a peer-to-peer (e.g., sidelink) connection. For example, the device may use a nearby device as a relay to receive the network outage reports and drive an OOS scanning algorithm at the device. The device can establish the peer-to-peer connection over a cellular network (e.g., LTE or NR sidelink).

In some examples, if the OOS scanning is triggered, then the device may continuously (e.g., periodically for a duration) perform OOS scans until a connection is established and/or until OOS scans are paused (e.g., at 326), at which point the device may return to 302 independent of which process the device is performing in the flowchart 300. That is, if the device has not paused OOS scans, then at any point after OOS scanning is triggered at 308, the device can establish or reestablish a network connection as a result of scanning.

At 314, if Wi-Fi is connected (e.g., “Yes” at 310), outage information is periodically requested. For example, the device uses the secondary wireless communications link to query an external source, such as an application server, for information related to the network outage. The information may include reports that indicate an outage in a same geographical location as the device. The request may include an indication of a geographical location of the device. In some cases, the device may dynamically adjust the periodicity that the information is requested, as described with reference to FIG. 2.

At 316, a determination is made as to whether outage information is received. If outage information is not received (e.g., “No”), then the device may return to 302 to attempt to establish the primary wireless communications link. If outage information is received (e.g., “Yes”), then at 318, a determination is made as to whether a network outage is detected based on the received information.

If a network outage is not detected (e.g., “No”), then at 320, the device may wait for the periodicity (e.g., expiry of a timer) before returning to 314. If a network outage is detected (e.g., “Yes”), then at 322, a determination is made as to whether the outage rate of change is decreasing. For example, the device may determine whether a number of outage reports is decreasing from the information obtained at 316. If the outage rate is not decreasing (e.g., “No”), then at 324, a determination is made as to whether the outage rate of change is increasing. For example, the device may determine whether a number of outage reports is increasing from the information obtained at 316. If the rate of change is increasing (e.g., “Yes”), then at 326, OOS scans are paused. For example, the device may pause attempts to establish a primary wireless communications link to conserve battery power. At 328, the device waits for Y multiples of an OOS scan timer. The value of Y may be an integer value configured (e.g., defined) via input or determined by the device. In some examples, at 330, a periodicity for requesting outage information is updated (e.g., adapted, modified). For example, the device may increase a periodicity (e.g., reduce a frequency) for obtaining the outage information to further reduce power consumption at the device. After updating the periodicity and/or if the rate is not increasing (e.g., “No”), then at 320, the device may wait for the periodicity (e.g., expiry of a timer) before returning to 314.

If the outage rate is decreasing at 324 (e.g., “Yes”), then at 332, periodic OOS scans are performed (e.g., resumed if the scans are previously paused at 326), and the device attempts to establish the primary wireless communications link at 302.

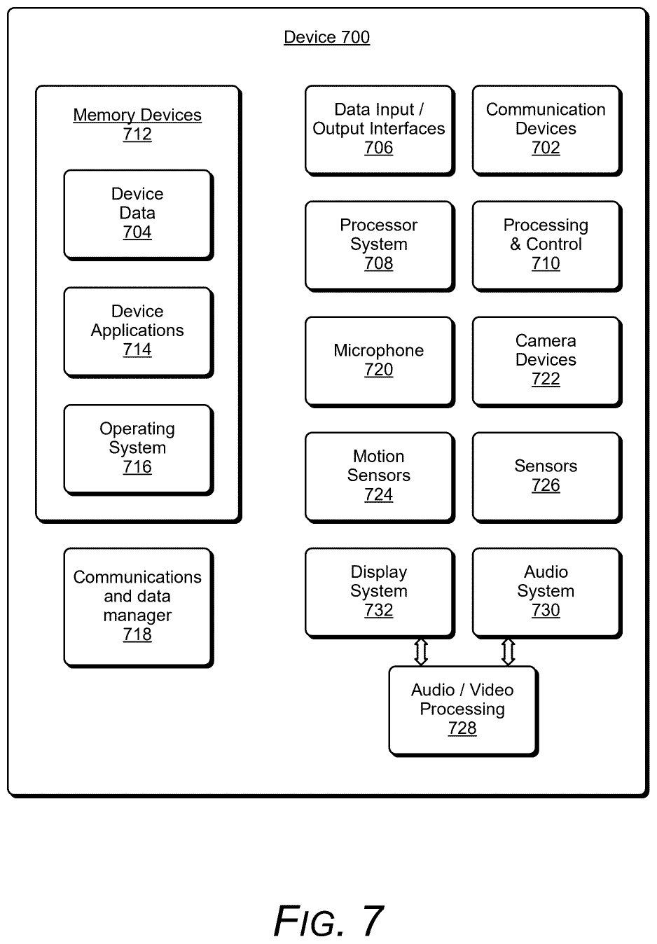

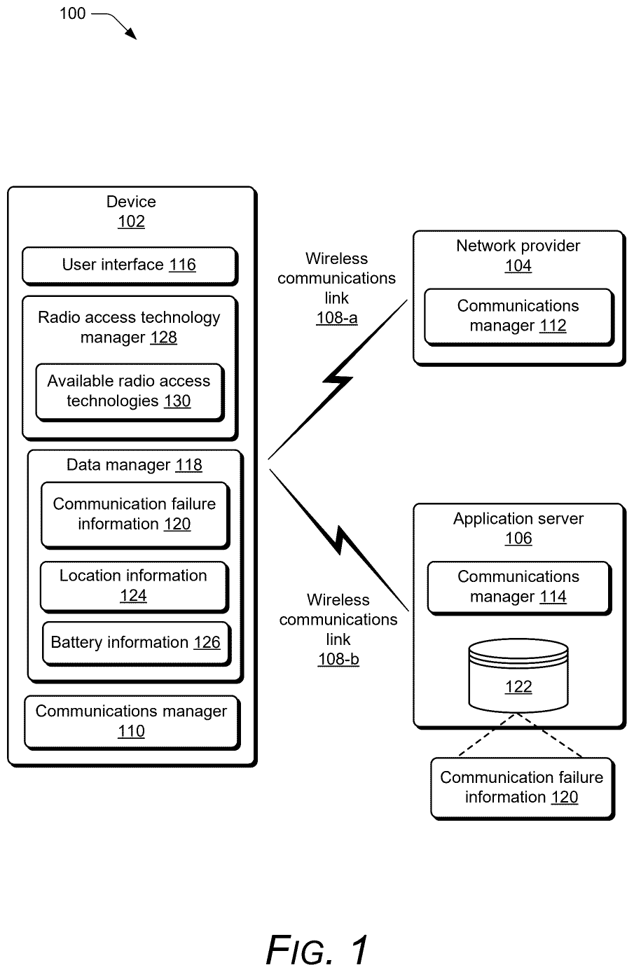

FIG. 4 illustrates an example user interface 400 for power conservation for wireless communications failure in accordance with one or more implementations as described herein. The example user interface 400 may implement aspects of the example system 100, the example report diagram 200, and/or the example flowchart 300. The example user interface 400 may include a device 102 that displays a user interface 116 upon detection of a communication failure, where the device 102 and the user interface 116 are examples of the corresponding devices and features as described with reference to FIG. 1.

A device 102 may detect a communication failure at a first wireless communications link, as described with reference to FIGS. 1 through 3. Upon detecting the communication failure, the device 102 may pause scans to reestablish or establish the first wireless communications link and generate a notification 402 to display via the user interface 116. The notification 402 informs the user that network connection has been lost, and scanning has been paused.

The notification 402 can include a text value, such as “Network connection lost! Battery enhancement mode enabled.” The device 102 can additionally display one or more interactable elements 404 via the user interface 116. The interactable elements 404 may include a button labeled “Disable” to disable the pausing of scanning (e.g., the battery enhancement mode), a button labeled “Done” to dismiss the notification, and a button labeled “Update settings” to modify the scanning criterion (a periodicity for scanning, whether the device 102 pauses scanning, etc.), among other example interactable elements 404.

In some examples, the device 102 may display additional information or controls in the user interface 116. For example, the device 102 may show details about the detected communication failure, such as the type of failure detected, or the estimated duration of the outage based on information received from an application server. The device 102 may also display options for the user to review or modify scanning settings, providing access to power management options.

If the device receives input selecting the “Disable” interactable element 404, then the device 102 may display a confirmation prompt, warning the user about the potential battery drain of resuming continuous scanning during a network outage. The prompt may include options to proceed with disabling the paused scanning or to cancel the action. If the device receives input indicating for the device to proceed, then the device may resume scans to establish a primary wireless communications link.

In some cases, the user interface 116 may include an “Update settings” option among the interactable elements 404. When selected, this option may open an interface for managing scanning behavior, providing for input to adjust the periodicity of outage information requests or modify the thresholds for resuming scanning based on outage trends.

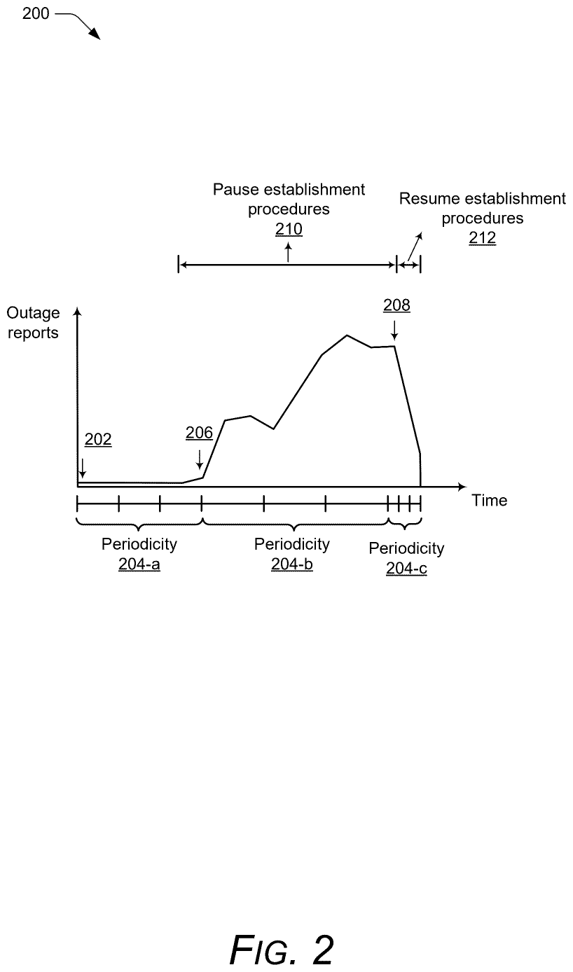

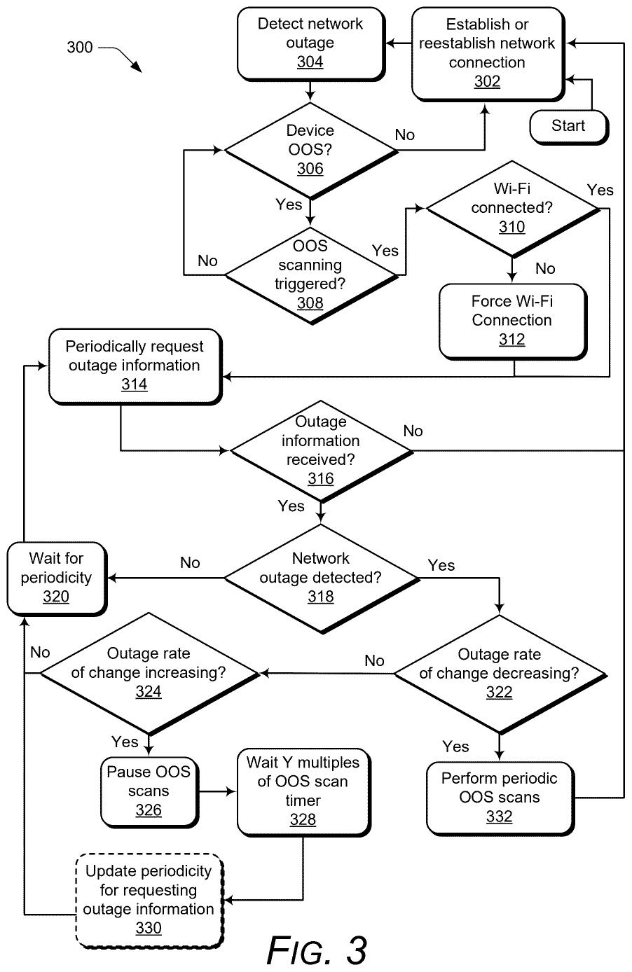

FIG. 5 illustrates an example method 500 for power conservation for wireless communications failure. The order in which the method is described is not intended to be construed as a limitation, and any number or combination of the described method operations can be performed in any order to perform a method, or an alternate method.

At 502, a communication failure is detected associated with a first wireless carrier that supports a first radio access technology. For example, a device detects a communication failure at a primary wireless communications link for a wireless carrier of a cellular network.

At 504, one or more scans to establish a first wireless communications link with the first wireless carrier are paused. For example, the device pauses attempts to reconnect to the wireless carrier of the cellular network to conserve battery power.

At 506, a second wireless communications link (e.g., with a second wireless carrier or a landline service for Wi-Fi) that supports a second radio access technology is established. For example, the device establishes a secondary wireless communications link for a secondary type of radio access technology (e.g., of a Wi-Fi network). The device establishes the connection with the Wi-Fi network to maintain network connectivity. In some cases, the first radio access technology and the second radio access technology may be different (e.g., Wi-Fi and cellular). In some other cases, the first radio access technology and the second radio access technology may be the same (e.g., two different Wi-Fi carriers or services, or two different cellular carriers, among other examples). To establish the second wireless communications link, the device may periodically scan for available radio access technologies according to a dynamic periodicity. The available radio access technologies can include the second radio access technology.

At 508, information associated with the communication failure is periodically received via the second wireless communications link. For example, the device uses the Wi-Fi connection to periodically obtain outage reports from an application server. In some cases, the information includes aggregated data from multiple devices experiencing respective communication failures associated with the first wireless carrier (e.g., of the primary wireless communications link, a wireless carrier of a cellular network). The multiple devices may be within a same geographic location as the device.

In some cases, the device obtains location information that indicates a geographic location of the device. The information received includes one or more reports that indicate respective communication failures related to the first wireless carrier at the geographic location. For example, the reports may be for a same network provider, a same wireless carrier, and/or for a same type of radio access technology as the communication failure at the device. A periodicity for periodically receiving the information may be dynamic based on a rate of change of the respective communication failures. For example, the device may adjust how frequently the device requests outage information according to whether reported outages are increasing or decreasing. The device may transmit the location information via the second wireless communications link, and the application server may provide outage reports for the geographic location of the device. Additionally, or alternatively, the device may determine the one or more reports from a set of received reports based on the one or more reports being associated with the geographic location. In some cases, the device may determine a battery level of the device fails to satisfy a threshold value (e.g., is below a threshold value). The device may reduce a periodicity for periodically receiving the information to conserve battery power. In some cases, the device may periodically transmit a request for the information to an application server. The device receives the information responsive to the request. The second wireless communications link is established between the device and the application server.

At 510, the scans to establish the first wireless communications link are resumed based on the information. For example, the device resumes attempts to reconnect to the cellular network when the outage reports indicate network recovery. The device may resume the attempts to reconnect to the cellular network by determining a rate of change of the respective communication failures satisfies a threshold value. For example, the device may resume connection attempts when the rate of reported outages decreases below a defined threshold value. The threshold value may be defined by the device and/or via user input received at the device or application server.

The device may periodically perform the scans to establish the first wireless communications link. The device may establish the first wireless communications link, including exchanging confirmation signaling with a network device to establish the first wireless communications link. In some cases, the first wireless communications link is between the network device and the device.

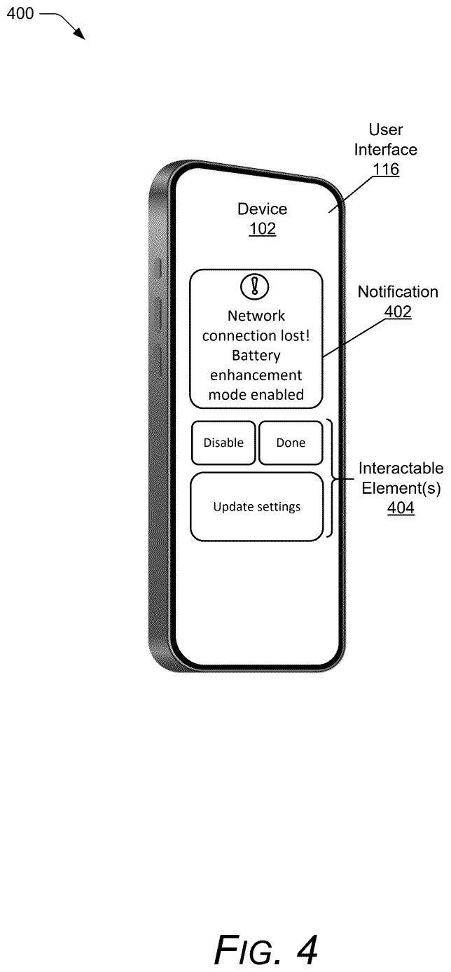

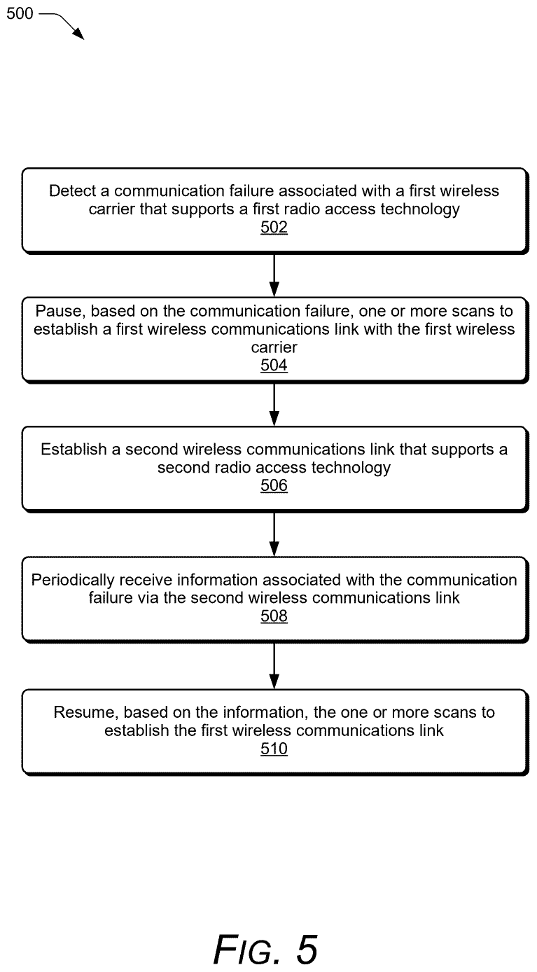

FIG. 6 illustrates an example method 600 for power conservation for wireless communications failure. The order in which the method is described is not intended to be construed as a limitation, and any number or combination of the described method operations can be performed in any order to perform a method, or an alternate method.

At 602, a communication failure is detected associated with a first wireless carrier that supports a first radio access technology. For example, a device detects a communication failure at a primary wireless communications link for a wireless carrier of a cellular network.

At 604, one or more scans to establish a first wireless communications link with the first wireless carrier are paused. For example, the device pauses attempts to reconnect to the wireless carrier of the cellular network to conserve battery power.

At 606, a second wireless communications link (e.g., with a second wireless carrier or a landline service for Wi-Fi) that supports a second radio access technology is established. For example, the device establishes a secondary wireless communications link for a secondary type of radio access technology (e.g., of a Wi-Fi network).

At 608, one or more reports that indicate respective communication failures associated with the first wireless carrier at a geographic location of the device are periodically received via the second wireless communications link. For example, the device uses the Wi-Fi connection to periodically obtain location-specific outage reports from an application server. The reports received by the device may include aggregated data from multiple devices experiencing communication failures associated with the first wireless carrier within the same geographic location. This aggregated information may provide a more comprehensive view of the network outage situation, providing for the device to determine when to resume connection attempts.

In some cases, the device may dynamically adjust the periodicity of receiving the reports based on the rate of change of the respective communication failures. The device may transmit location information that indicates a geographic location of the device via the second wireless communications link to receive location-specific outage reports. In some cases, the device may determine a battery level when determining the periodicity of receiving the reports. If the battery level falls below a threshold value, then the device may reduce the frequency of report requests to conserve power (e.g., during extended outages).

At 610, based on a rate of change of the respective communication failures satisfying a threshold value, the scans to establish the first wireless communications link are resumed. For example, the device resumes attempts to reconnect to the cellular network when the rate of reported outages decreases below a certain threshold.

The example flowchart 300, the example method 500, and the example method 600, are described with reference to respective FIGS. 3, 5, and 6 in accordance with one or more implementations of power conservation for wireless communications failure, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 7 illustrates various components of an example device 700, which can implement aspects of the techniques and features for power conservation for wireless communications failure, as described herein. The example device 700 can be implemented as any of the devices described with reference to the previous FIGS. 1 through 6, such as any type of a wireless device, mobile device, mobile phone, flip phone, client device, companion device, paired device, display device, tablet, wearable device, computing, communication, entertainment, gaming, media playback, and/or any other type of computing, consumer, and/or electronic device. For example, the device 102, the network provider 104, and/or the application server 106, as described with reference to FIGS. 1 through 6, may be implemented as the example device 700.

The example device 700 can include various, different communication devices 702 that enable wired and/or wireless communication of device data 704 with other devices. The device data 704 can include any of the various device's data and content that is generated, processed, determined, received, stored, and/or communicated from one computing device to another. Generally, the device data 704 can include any form of audio, video, image, graphics, and/or electronic data that is generated by applications executing on a device. The communication devices 702 can also include transceivers for cellular phone communication and/or for any type of network data communication.

The example device 700 can also include various, different types of data input/output (I/O) interfaces 706, such as data network interfaces that provide connection and/or communication links between the devices, data networks, and other devices. The I/O interfaces 706 can be used to couple the device to any type of components, peripherals, and/or accessory devices, such as a computer input device that may be integrated with the example device 700. The I/O interfaces 706 may also include data input ports via which any type of data, information, media content, communications, messages, and/or inputs can be received, such as user inputs to the device, as well as any type of audio, video, image, graphics, and/or electronic data received from any content and/or data source.

The example device 700 includes a processor system 708 of one or more processors (e.g., any of microprocessors, controllers, and the like) and/or a processor and memory system implemented as a SoC that processes computer-executable instructions. The processor system 708 may be implemented at least partially in computer hardware, which can include components of an integrated circuit or on-chip system, an ASIC, a FPGA, a CPLD, and other implementations in silicon and/or other hardware. Alternatively, or in addition, the device can be implemented with any one or combination of software, hardware, firmware, or fixed logic circuitry that may be implemented in connection with processing and control circuits, which are generally identified as processing and control 710. The example device 700 may also include any type of a system bus or other data and command transfer system that couples the various components within the device. A system bus can include any one or combination of different bus structures and architectures, as well as control and data lines.

The example device 700 also includes memory and/or memory devices 712 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 712 include volatile memory and non-volatile memory, fixed and removable media devices, and any suitable memory device or electronic data storage that maintains data for computing device access. The memory devices 712 can include various implementations of random-access memory (RAM), read-only memory (ROM), flash memory, and other types of storage media in various memory device configurations. The example device 700 may also include a mass storage media device.

The memory devices 712 (e.g., as computer-readable storage memory) provide data storage mechanisms, such as to store the device data 704, other types of information and/or electronic data, and various device applications 714 (e.g., software applications and/or modules). For example, an operating system 716 can be maintained as software instructions with a memory device 712 and executed by the processor system 708 as a software application. The device applications 714 may also include a device manager, such as any form of a control application, software application, signal-processing and control module, code that is specific to a particular device, a hardware abstraction layer for a particular device, and so on.

In this example, the device 700 includes a communications and data manager 718 that implements various aspects of the described features and techniques described herein. The communications and data manager 718 can be implemented with hardware components and/or in software as one of the device applications 714, such as when the example device 700 is implemented as the device 102 described with reference to FIGS. 1 through 6. An example of the communications and data manager 718 is the communications manager 110 and/or the data manager 118 implemented in the device 102, such as a software application and/or as hardware components in the wireless device. In one or more implementations, the communications and data manager 718 may include independent processing, memory, and logic components as a computing and/or electronic device integrated with the example device 700.

The example device 700 can also include a microphone 720 and/or camera devices 722, as well as proximity and/or motion sensors 724, such as may be implemented as components of an inertial measurement unit (IMU), and geographical location information sensors (e.g., GPS to obtain a current geographic location of the client device or a user of the client device). The proximity and/or motion sensors 724 can be implemented with various sensors 726, such as a gyroscope, an accelerometer, and/or other types of motion sensors to sense motion of the device. The motion sensors 724 can generate sensor data vectors having three-dimensional parameters (e.g., rotational vectors in x, y, and z-axis coordinates) indicating location, position, acceleration, rotational speed, and/or orientation of the device. The example device 700 can also include one or more power sources, such as when the device is implemented as a wireless device and/or a device 102. The power sources may include a charging and/or power system, and can be implemented as a flexible strip battery, a rechargeable battery, a charged super-capacitor, and/or any other type of active or passive power source.

The example device 700 can also include an audio and/or video processing system 728 that generates audio data for an audio system 730 and/or generates display data for a display system 732. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In one or more implementations, the audio system and/or the display system are integrated components of the example device 700. Alternatively, the audio system and/or the display system are external, peripheral components to the example device.

Although implementations of power conservation for wireless communications failure have been described in language specific to features and/or methods, the appended claims are not necessarily limited to the specific features or methods described. Rather, the specific features and methods are disclosed as example implementations for power conservation for wireless communications failure, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a device for wireless communications, the device including at least one memory, and at least one processor coupled with the at least one memory and configured to cause the device to detect a communication failure associated with a first wireless carrier that supports a first radio access technology, pause, based on the communication failure, one or more scans to establish a first wireless communications link with the first wireless carrier, establish a second wireless communications link that supports a second radio access technology, periodically receive information associated with the communication failure via the second wireless communications link, and resume, based on the information, the one or more scans to establish the first wireless communications link.

In some aspects, the techniques described herein relate to a device, where the at least one processor is further configured to cause the device to obtain location information that indicates a geographic location of the device, where the information includes one or more reports that indicate respective communication failures associated with the first wireless carrier at the geographic location.

In some aspects, the techniques described herein relate to a device, where to resume the one or more scans to establish the first wireless communications link, the at least one processor is configured to cause the device to determine a rate of change of the respective communication failures satisfies a threshold value.

In some aspects, the techniques described herein relate to a device, where a periodicity associated with periodically receiving the information is dynamic based on a rate of change of the respective communication failures.

In some aspects, the techniques described herein relate to a device, where the at least one processor is further configured to cause the device to transmit the location information via the second wireless communications link, where the information includes the one or more reports based on the location information.

In some aspects, the techniques described herein relate to a device, where the at least one processor is further configured to cause the device to determine the one or more reports from a set of reports based on the one or more reports being associated with the geographic location, where the information includes the set of reports.

In some aspects, the techniques described herein relate to a device, where to periodically receive the information, the at least one processor is configured to cause the device to determine a battery level of the device fails to satisfy a threshold value, and reduce a periodicity associated with periodically receiving the information.

In some aspects, the techniques described herein relate to a device, where to establish the second wireless communications link, the at least one processor is configured to cause the device to periodically scan, based on a dynamic periodicity, for available radio access technologies, where the available radio access technologies include the second radio access technology.

In some aspects, the techniques described herein relate to a device, where the first wireless carrier is different from a second wireless carrier associated with the second wireless communications link.

In some aspects, the techniques described herein relate to a device, where the at least one processor is further configured to cause the device to periodically perform the one or more scans to establish the first wireless communications link, and establish, based on the one or more scans, the first wireless communications link, where the first wireless communications link is between a network device and the device.

In some aspects, the techniques described herein relate to a device, where the at least one processor is further configured to cause the device to periodically transmit, to an application server and based on a dynamic periodicity, a request for the information, where the information is received responsive to the request, and where the second wireless communications link is established between the device and the application server.

In some aspects, the techniques described herein relate to a device, where the information includes aggregated data from multiple devices experiencing respective communication failures associated with the first wireless carrier, and where the multiple devices are within a same geographic location as the device.

In some aspects, the techniques described herein relate to a method performed by a device, the method including detecting a communication failure associated with a first wireless carrier that supports a first radio access technology, pausing, based on the communication failure, one or more scans to establish a first wireless communications link with the first wireless carrier, establishing a second wireless communications link that supports a second radio access technology, periodically receiving information associated with the communication failure via the second wireless communications link, and resuming, based on the information, the one or more scans to establish the first wireless communications link.

In some aspects, the techniques described herein relate to a method, further including obtaining location information that indicates a geographic location of the device, where the information includes one or more reports that indicate respective communication failures associated with the first wireless carrier at the geographic location.

In some aspects, the techniques described herein relate to a method, where periodically receiving the information includes determining a battery level of the device fails to satisfy a threshold value, and reducing a periodicity associated with periodically receiving the information.

In some aspects, the techniques described herein relate to a method, where establishing the second wireless communications link includes periodically scanning, based on a dynamic periodicity, for available radio access technologies, where the available radio access technologies include the second radio access technology.

In some aspects, the techniques described herein relate to a method, where the first wireless carrier is different from a second wireless carrier associated with the second wireless communications link.

In some aspects, the techniques described herein relate to a method, further including periodically performing the one or more scans to establish the first wireless communications link, and establish, based on the one or more scans, the first wireless communications link, where the first wireless communications link is between a network device and the device.

In some aspects, the techniques described herein relate to a method, further including periodically transmitting, to an application server and based on a dynamic periodicity, a request for the information, where the information is received responsive to the request, and where the second wireless communications link is established between the device and the application server.

In some aspects, the techniques described herein relate to a method, where the information includes aggregated data from multiple devices experiencing respective communication failures associated with the first wireless carrier, and where the multiple devices are within a same geographic location as the device.

In some aspects, the techniques described herein relate to a system, including a first radio device associated with a first radio access technology, at least a second radio device associated with a second radio access technology, and a communications manager to detect, by the first radio device, a communication failure associated with a first wireless carrier that supports the first radio access technology, pause, by the first radio device and based on the communication failure, one or more scans to establish a first wireless communications link with the first wireless carrier, establish, by the second radio device, a second wireless communications link that supports the second radio access technology, periodically receive, by the second radio device, information associated with the communication failure via the second wireless communications link, and resume, by the first radio device and based on the information, the one or more scans to establish the first wireless communications link.

In some aspects, the techniques described herein relate to a system, where the communications manager is further configured to obtain a geographic location of the system, where the information includes one or more reports that indicate respective communication failures associated with the first wireless carrier at the geographic location.

1. A device for wireless communications, the device comprising:
at least one memory; and
at least one processor coupled with the at least one memory and configured to cause the device to:
detect a communication failure associated with a first wireless carrier that supports a first radio access technology;
pause, based on the communication failure, one or more scans to establish a first wireless communications link with the first wireless carrier;
establish a second wireless communications link that supports a second radio access technology;
periodically receive information associated with the communication failure via the second wireless communications link; and
resume, based on the information, the one or more scans to establish the first wireless communications link.

2. The device of claim 1, wherein the at least one processor is further configured to cause the device to obtain location information that indicates a geographic location of the device, wherein the information includes one or more reports that indicate respective communication failures associated with the first wireless carrier at the geographic location.

3. The device of claim 2, wherein to resume the one or more scans to establish the first wireless communications link, the at least one processor is configured to cause the device to determine a rate of change of the respective communication failures satisfies a threshold value.

4. The device of claim 2, wherein a periodicity associated with periodically receiving the information is dynamic based on a rate of change of the respective communication failures.

5. The device of claim 2, wherein the at least one processor is further configured to cause the device to transmit the location information via the second wireless communications link, wherein the information includes the one or more reports based on the location information.

6. The device of claim 2, wherein the at least one processor is further configured to cause the device to determine the one or more reports from a set of reports based on the one or more reports being associated with the geographic location, wherein the information includes the set of reports.

7. The device of claim 1, wherein to periodically receive the information, the at least one processor is configured to cause the device to:
determine a battery level of the device fails to satisfy a threshold value; and
reduce a periodicity associated with periodically receiving the information.

8. The device of claim 1, wherein to establish the second wireless communications link, the at least one processor is configured to cause the device to periodically scan, based on a dynamic periodicity, for available radio access technologies, wherein the available radio access technologies include the second radio access technology, and wherein the first wireless carrier is different from a second wireless carrier associated with the second wireless communications link.

9. The device of claim 1, wherein the at least one processor is further configured to cause the device to:
periodically perform the one or more scans to establish the first wireless communications link; and
establish, based on the one or more scans, the first wireless communications link, wherein the first wireless communications link is between a network device and the device.

10. The device of claim 1, wherein the at least one processor is further configured to cause the device to periodically transmit, to an application server and based on a dynamic periodicity, a request for the information, wherein the information is received responsive to the request, and wherein the second wireless communications link is established between the device and the application server.

11. The device of claim 1, wherein the information includes aggregated data from multiple devices experiencing respective communication failures associated with the first wireless carrier, and wherein the multiple devices are within a same geographic location as the device.

12. A method performed by a device, the method comprising:
detecting a communication failure associated with a first wireless carrier that supports a first radio access technology;
pausing, based on the communication failure, one or more scans to establish a first wireless communications link with the first wireless carrier;
establishing a second wireless communications link that supports a second radio access technology;
periodically receiving information associated with the communication failure via the second wireless communications link; and
resuming, based on the information, the one or more scans to establish the first wireless communications link.

13. The method of claim 12, further comprising obtaining location information that indicates a geographic location of the device, wherein the information includes one or more reports that indicate respective communication failures associated with the first wireless carrier at the geographic location.

14. The method of claim 12, wherein periodically receiving the information comprises:
determining a battery level of the device fails to satisfy a threshold value; and
reducing a periodicity associated with periodically receiving the information.

15. The method of claim 12, wherein establishing the second wireless communications link comprises periodically scanning, based on a dynamic periodicity, for available radio access technologies, wherein the available radio access technologies include the second radio access technology, and wherein the first wireless carrier is different from a second wireless carrier associated with the second wireless communications link.

16. The method of claim 12, further comprising:
periodically performing the one or more scans to establish the first wireless communications link; and
establish, based on the one or more scans, the first wireless communications link, wherein the first wireless communications link is between a network device and the device.

17. The method of claim 12, further comprising periodically transmitting, to an application server and based on a dynamic periodicity, a request for the information, wherein the information is received responsive to the request, and wherein the second wireless communications link is established between the device and the application server.

18. The method of claim 12, wherein the information comprises aggregated data from multiple devices experiencing respective communication failures associated with the first wireless carrier, and wherein the multiple devices are within a same geographic location as the device.

19. A system, comprising:
a first radio device associated with a first radio access technology;
at least a second radio device associated with a second radio access technology; and
a communications manager to:
detect, by the first radio device, a communication failure associated with a first wireless carrier that supports the first radio access technology;
pause, by the first radio device and based on the communication failure, one or more scans to establish a first wireless communications link with the first wireless carrier;
establish, by the second radio device, a second wireless communications link that supports the second radio access technology;
periodically receive, by the second radio device, information associated with the communication failure via the second wireless communications link; and
resume, by the first radio device and based on the information, the one or more scans to establish the first wireless communications link.

20. The system of claim 19, wherein the communications manager is further configured to obtain a geographic location of the system, wherein the information includes one or more reports that indicate respective communication failures associated with the first wireless carrier at the geographic location.
